(19) United States
(12) Patent Application Publication
(10) Pub. No.: US 2007/0157512 A1
(43) Pub. Date: Jul. 12, 2007

(54) Electronic measuring or control device used for watering plants

(75) Inventors: Reinhold Wein, Kallnach (CH); Erich Baumgartner, Ruhrmoos (DE)

Correspondence Address: BROWDY AND NEIMARK, P.L.L.C.;624 NINTH STREET, NW, SUITE 300, WASHINGTON, DC, 20001-5303, US

(73) Assignee: FLORASYS AG, LYSS (CH)

(21) Appl. No.: 10/586,249

(22) PCT Filed: Jan. 17, 2005
(86) PCT No.: PCT/EP05/00395

§ 371 Date: Jul. 17, 2006

(30) Foreign Application Priority Data
Jan. 16, 2004 (DE) 10 2004 002 271.2

(51) Int. Cl. A01G 29/00

(52) U.S. Cl. 47/48.5; 137/78.3; 324/664

(57) ABSTRACT

Disclosed is an electronic control device (21) for watering plants, comprising at least one electronic moisture sensor (1) based on a moisture-sensitive capacitor (5) for measuring the moisture of the dirt. Said capacitor is provided with a dielectric (8) whose dielectric coefficient changes when moisture penetrates thereinto.

The invention relates to an electronic measuring or control device for watering plants based on an electronic moisture sensor that converts the soil moisture of the plants being monitored by it into an electric signal. The invention additionally relates to this electronic moisture sensor itself.

With respect to the prior art, it may be stated that interval-controlled watering systems with adjustable watering times are known. These have the shortcoming that the temperature and, hence, the degree of evaporation within the watering intervals, as well as the existing soil moisture are not taken into account. This means that in the case of an incorrect time interval, the plant being monitored may receive too little or too much water. A watering system of this type, which is time-controlled, is known, for example. from DE 101 06 266 A1.

Moreover, it is known that water level indicators that have a float placed inside a clear tube are used in so-called hydrocultures, to monitor the watering of plants. This does not entail visually indicating the soil moisture of a conventional planter. This means there is no permanent monitoring of the soil moisture with a corresponding visual indication of the plant-specific moisture requirement.

Lastly, in the field of the moisture sensors themselves, sensors are known for measuring the relative humidity of air. For moisture measurement in soil, electro-dynamic methods are used, such as the so-called TDR (Time Domain Reflectrometry) principle of measurement.

The present invention has as its object to present an electronic measuring or control device for watering plants based on all electronic moisture sensor, as well as such an electronic moisture sensor itself that is simple in its construction but makes available in a reliable manner a suitable electric signal to measure the soil moisture of the plant being monitored and for further processing in the measuring or control device for a precisely targeted water application.

This object is met with an electronic measuring or control device for watering plants having an electronic moisture sensor according to the characterizing portion of claim 1, and with an electronic moisture sensor itself according to claim 17.

The gist of the invention is the design of the electronic moisture sensor based on a moisture-sensitive capacitor for measuring the soil moisture, which is provided with a dielectric whose dielectric constant changes when moisture penetrates into it. The change in the dielectric constant can be measured and evaluated by means of suitable electronics. The corresponding electric signal is then regarded as the basis for the soil moisture measurement and control of the water application with the aid of the electronic measuring or control device, in dependence upon its particular design.

With regard to construction costs, a capacitor that is moisture based in terms of its dielectric constant can be implemented mechanically simple and cost-effectively in a great variety of design types.

Corresponding preferred embodiments of the electronic moisture sensor, as they will be discussed in more detail in the description of the example embodiments, are specified in subclaims 2 through 7.

Additional preferred embodiments of the measuring or control device are specified in claims 8 through 16. Claim 8, for example, relates to the measurement and evaluation of the moisture-based changing capacitance of the moisture sensor, with the aid of electronics that may be analog or preferably microprocessor-based.

The interface as specified in claim 9 for transmission of individual plant-specific parameters, such as their intrinsic moisture requirement and corresponding watering data, permits the measuring or control unit to be individually adapted to the given plant species being monitored. This makes it possible, on one hand, in the case of an implementation of the inventive object as a measuring device, to activate a warming light, such as a light-emitting diode or alphanumeric display, e.g., an LCD display or the like, by means of the electronics based on the specified individual plant-specific data, for a visual display of the performed measurements. This permits the measuring device to signal that a watering need exists for the plant being monitored. During watering, the moisture of the soil changes, which can again be detected by the measuring device and used for the visually discernable display of a cease-watering signal (claim 10).

As a result of the variable or fixed resistance circuit that is provided in accordance with claim 11, threshold values can be set in the case of analog electronics, for the visualization of a watering need and/or cessation of watering.

The temperature sensor provided according to claim 12 for measuring the ambient temperature makes available a signal that is processable by the electronics of the measuring or control device, whereby the individual drying times of the plant roots for the required oxygen supply can be calculated.

The above implementation of the subject matter in the form of a measuring device used for supporting a manual water application can also be used to implement a control device for fully automatic watering, in which an integrated watering valve for watering of the plant can then be actuated by the electronics (claim 13).

The fill-level-monitored water reservoir according to claim 14, the liquid-fertilizer supply according to claim 15, as well as the pH sensor according to claim 16 serve to further optimize the control unit for a species-appropriate watering and care of the plant that is provided with the control device.

It should also be pointed out that the measuring or control device with its evaluation and control electronics according to claims 8 through 15 can also be operated using a moisture sensor of a different type.

Additional characteristics, details and advantages of the invention will become apparent from the following description, in which example embodiments will be explained in more detail based on the appended drawings, in which:

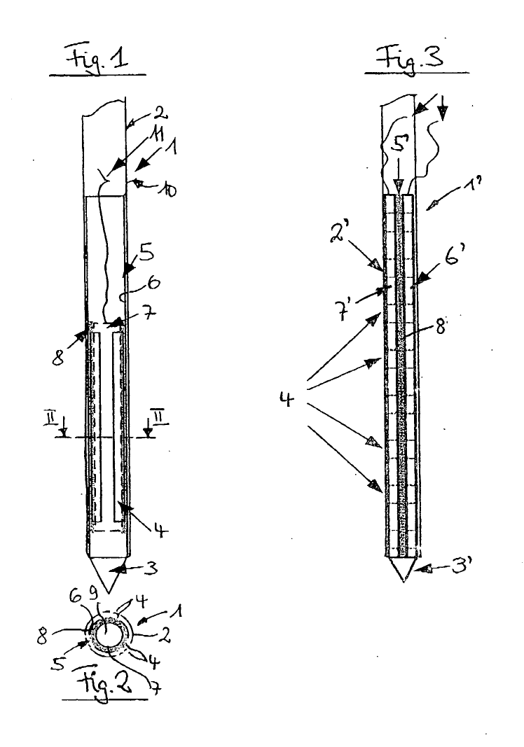

FIG. 1 shows a highly schematic side view of an electronic moisture sensor in a first embodiment,

FIG. 2 shows a cross section through the moisture sensor according to the section line II-II of FIG. 1,

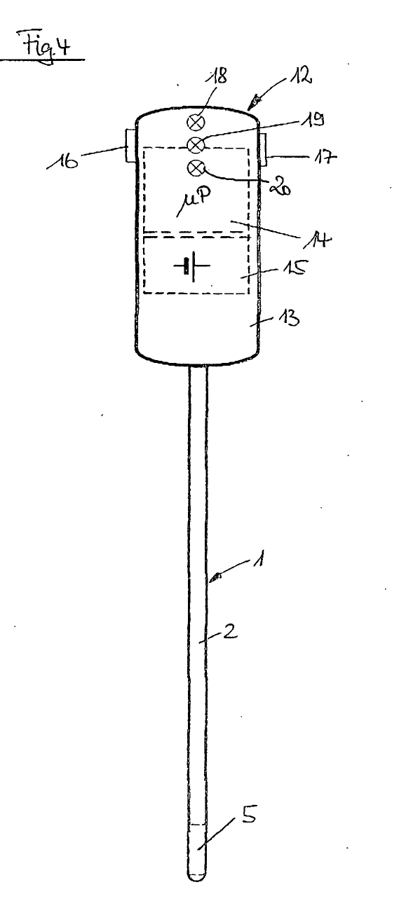

FIG. 3 shows a highly schematic side view of a moisture sensor in a second embodiment,

FIG. 4 shows a schematic front view of an electronic measuring device for the soil moisture of a watered plant,

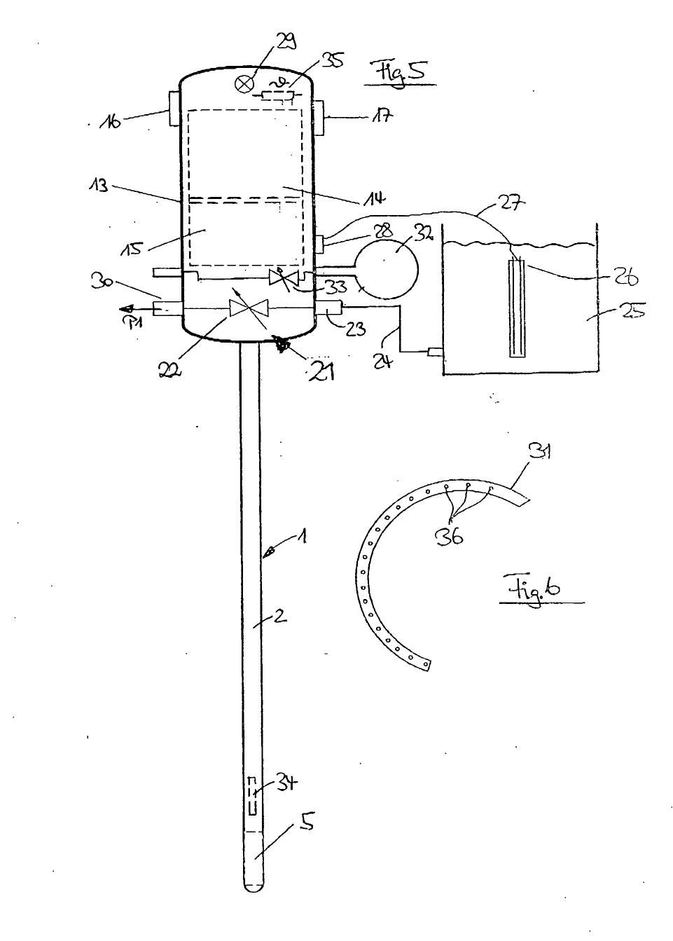

FIG. 5 shows a schematic front view of a control device for watering of a plant, and

FIG. 6 shows a top view of a watering ring for the plant supplied by the control device according to FIG. 5.

The moisture sensor 1 shown in FIG. 1 incorporates an elongated tubular housing 2 made of an insulating synthetic material. At its end that is to be inserted into the root ball of a plant (not depicted) being monitored with respect to its moisture, this housing 2 is provided with a sharpening 3 for ease of penetration of the sensor. At a distance from this end, a plurality of slits 4 are provided in the housing 2, distributed over its circumference and extending parallel to the longitudinal axis, through which the moisture can penetrate from the root ball into the interior of the housing 2.

The actual moisture-sensitive capacitor in the interior of the housing 2 is marked with the reference numeral 5, said moisture-sensitive capacitor comprising an outer tube-like capacitor terminal 6 and, arranged at a distance radially inward from the same, an inner capacitor terminal 7 of round cross section. Both capacitor terminals 6, 7, are formed by an appropriately bent, thin, single-layer aluminum foil having a thickness of, for example, 50 μm. The outer capacitor terminal 6, in this case, has perforations in alignment with the slits 4, also for the penetrating moisture.

Arranged between the two capacitor terminals 6, 7, is a dielectric 8 that releases or absorbs moisture depending on the moisture content of the surrounding environment, said dielectric 8 consisting of a glass fiber mat. The latter is formed by a pressed glass-fiber felt or glass-fiber fabric.

For stabilization, the inner capacitor terminal 7 sits on an electrically insulating support core 9.

Leads 10, 11 connect the two capacitor terminals 6, 7 to evaluation electronics, which will be discussed in more detail based on FIGS. 4 and 5, of the measuring and/or control device for the watering of plants.

In the embodiment of the moisture sensor 1′ as shown in FIG. 3, components that correspond to the variant according to FIGS. 1 and 2 are marked with identical reference numerals and do not need to be explained further. Explanations shall be provided only for the differences. These consist especially of the formation of the capacitor 5′ by two elongated flat capacitor plates 6′, 7′ positioned at a distance from each other, between which the dielectric 8 is disposed, which is again implemented in the form of a glass fiber mat. To allow the moisture to penetrate, the housing 2′, which is rectangular in cross section, and the two capacitor terminals 6′, 7′ are provided with slits 4 that extend through to the dielectric 8.

The measuring device 12 shown in FIG. 4 has a housing 13, to which the rod-shaped moisture sensor 1 with the capacitor 5, which is shown in more detail in FIG. 1, is affixed. Accommodated inside the housing 13 are the microprocessor-based electronics 14 that energize the two capacitor terminals 6, 7 with an AC voltage. When the moisture in the dielectric 8 changes, its dielectric constant changes, and so does the capacitance of the capacitor arrangement 5, resulting in a frequency shift of the oscillator. This is measured by the electronics 14 and processed into a moisture-based signal.

The power supply for the electronics 14 and all other components is ensured with an optionally rechargeable battery 15 housed in a corresponding battery compartment inside the housing 13. For charging of the battery 15, the housing 13 has provided on it a connector element 16 for connection to a charge cable (not shown).

Additionally, the housing 13 has a data interface 17 for transmission of individual plant-specific parameters, such as species-appropriate watering data, or for the readout of statistical data, such as the duration of underwatering or overwatering periods.

Based on the plant-specific watering data, the electronics 14 determine the respective optimum moisture bandwidth for the given plant that is provided with the measuring device. The determined actual moisture of the root ball is then linked to this bandwidth and its value is visualized by means of three light-emitting diodes 18, 19, 20 that are affixed on the outside of the housing 13. If the correct moisture content is present, the middle light-emitting diode 19, for example, may be activated by the electronics 14 and emit a light of green color. If the plant is drying out and the moisture content of the root ball drops below a lower limit of the moisture bandwidth, the lower light-emitting diode 20 is activated and is then illuminated red, for example. The plant is then watered, the increase in moisture as determined by the moisture sensor 1 is evaluated by the electronics 14, which, lastly, when the correct moisture level is reached, again activates the middle light-emitting diode 19. If watering is excessive and the moisture accordingly exceeds the upper limit value of the correct moisture bandwidth, the upper LED 18 may be activated. A corresponding red light signal thus provides a visually discernable cease-watering warning signal.

FIG. 5 shows a control device 21 for automatic watering of a planter (not shown in detail). This control device 21, again, has provided on its housing 13 a rod-shaped moisture sensor 1 with a capacitor 5 at the end to be inserted into the root ball of the supplied plant. In conformity with the measuring, device 12 according to FIG. 4, provision is again made for corresponding electronics 14, a battery 15, a connector element 16 for connection of a cable for charging the battery 15, as well a data interface 17. As already mentioned above, this data interface 17 may be used for plant-specific watering data to be read in. Since an active watering of the plant—which will be discussed below—is performed in the embodiment according to the present FIG. 5, the cumulative actual watering times, for example, can be read out via the data interface 17.

The control device 21 has integrated into it, for active watering of the plant, a watering valve 22, whose opening and closing is controlled by the electronics 14 in dependence upon the detected water requirement of the plant. The watering valve 22 is connected via an inlet connection piece 23 and corresponding water line 24 to a water reservoir 25, whose content, in turn, may be monitored via a fill level sensor 26 by the electronics 14. To achieve this, the fill level sensor 26 is in signal connection with the electronics 14 via a signal line 27 with a corresponding connector jack 26 on the housing 13. As soon as the fluid level in the water reservoir 25 drops below a lower limit, the electronics 14 activate the light-emitting diode 29, which then emits a warning blinking signal.

From the watering valve 22, liquid is released via the outlet connection piece 30 when a requirement is detected by the electronics 14. The outlet connection piece 30, in this case, is connected via tubing (not shown) to the watering ring 31 depicted in FIG. 6 (arrow P1. This watering ring 31, which is partially open along its circumference, is provided with drip holes 36 that are evenly distributed along its circumference.

To provide for additional plant care, the control device 21 is equipped with a liquid-fertilizer reservoir 32, which feeds a liquid-fertilizer valve 33 in the control device 21. The latter is again controlled via the electronics 14, in order to release liquid fertilizer to the plant in appropriate fertilization intervals via corresponding tubing (arrow P2).

Additionally, the control device 21 is provided with a pH sensor 34 for measuring the PH of the plant soil of the plant monitored by the control device. This pH sensor 34 is also affixed on the end of the moisture sensor 1 to be inserted into the root ball.

To monitor the room temperature, which plays an important role for the degree of drying-out of the plant, the control device 21 additionally has a temperature sensor 35, whose signal is detected and evaluated by the electronics 14 in the same way as that of the pH sensor 34.

1. An electronic measuring or control device for watering plants,
comprising
at least one electronic moisture sensor (1, 1′) based on a moisture-sensitive capacitor (5, 5′) for measuring the moisture of the soil, having a dielectric (8) whose dielectric constant changes when moisture penetrates into it.

2. A measuring or control device according to claim 1, comprising a moisture-releasing and absorbing dielectric (8), especially in the form of a glass fiber mat.

3. A measuring or control device according to claim 1, wherein the capacitor (5) of the moisture sensor has an outer tube-like capacitor terminal (6) and an inner capacitor terminal (7) of round cross section, between which the dielectric (8) is arranged accessible from outside to moisture.

4. A measuring or control device according to claim 3, wherein the capacitor terminals (6, 7) are formed by a thin aluminum foil.

5. A measuring or control device according to claim 1, wherein the capacitor (5′) of the moisture sensor is implemented as a plate capacitor having two capacitor plates (6′, 7′) and a dielectric (8) arranged between them accessible to moisture.

6. A measuring or control device according to claim 3, wherein the dielectric (8) is accessible to moisture via openings (4) in at least one of the capacitor terminals (6, 7; 6′, 7′).

7. A measuring or control device according to claim 1, wherein the moisture sensor (1, 1′), for ease of insertion into a root ball of a plant, is provided with a sharpening (3).

8. A measuring or control device according to claim 1, wherein the moisture-based signal of the moisture sensor (1, 1′) can preferably be measured and evaluated by means of microprocessor-based electronics (14).

9. A measuring or control device according to claim 8, wherein it is provided with an interface (17) for transmission of individual plant-specific parameters, such as especially watering data, to the electronics (14), and/or for readout of statistical data, such as watering times.

10. A measuring or control device according to claim 8, wherein a display (18, 19, 20) for visual representation of the measured values can be activated by means of the electronics (14) in accordance with the individual plant-specific parameters.

11. A measuring or control device according to claim 8, wherein threshold values for the visualization of a watering need or cessation of watering can be set in the electronics (14) by means of a variable or fixed resistance circuit.

12. A measuring or control device according to claim 8, comprising a temperature sensor (35) for measuring the ambient temperature.

13. A measuring or control device according to claim 8, comprising an integrated watering valve (22) that can be activated by the electronics (14) for watering of the plant.

14. A measuring or control device according to claim 13, comprising a water reservoir (25) for supplying the watering valve (22), the fill level of the water reservoir (25) being monitorable by the electronics (14) by means of a fill-level sensor (26).

15. A measuring or control device according to claim 8, comprising a liquid-fertilizer reservoir (32) and an integrated fertilizer valve (33) supplied by it that can be activated by the electronics (14) in parameterizable intervals.

16. A measuring or control device according to claim 1, comprising a pH sensor (34) for measuring the pH of the plant soil of the plant being monitored by the measuring and/or control device.

17. An electronic moisture sensor (1, 1′) especially for use in a measuring or control device (12, 21) for watering of plants according to the characterizing portion of at least claim 1.
